(19) United States
(12) Patent Application Publication
(10) Pub. No.: US 2017/0058073 A1
(43) Pub. Date: Mar. 2, 2017

(54) SYNTHESIS AND APPLICATION OF FORMALDEHYDE FREE MELAMINE GLUTARALDEHYDE AMINO RESIN AS AN EFFECTIVE RETANNING AGENT

(71) Applicants: COMSATS Institute of Information Technology, Islamabad (PK); GC University, Lahore (PK)

(72) Inventors: Rashid SALEEM, Lahore (PK); Ahmad ADNAN, Lahore (PK); Fahim Ashraf QURESHI, Islamabad (PK)

(21) Appl. No.: 15/243,184

(22) Filed: Aug. 22, 2016

(30) Foreign Application Priority Data
Aug. 25, 2015 (PK) 5452015

(51) Int. Cl. C08G 12/32; C14C 3/22

(52) U.S. Cl. CPC C08G 12/32; C14C 3/22

(57) ABSTRACT

A method of synthesizing a resin including mixing a first solution including a melamine compound with a second solution including glutaraldehyde to form a third solution, heating the third solution to 35° C. to 90° C. in at a pH above 7 for 5 to 70 minutes, and cooling the third solution to room temperature.

### CROSS-REFERENCE TO RELATED APPLICATION

This application claims priority from and the benefit of Pakistan Patent Application No. 545/2015, filed on Aug. 25, 2015, which is hereby incorporated by reference for all purposes as if fully set forth herein.

### BACKGROUND

Field

Exemplary embodiments of the present invention relate to a method to synthesize a novel melamine-based resin for use as a retanning agent.

Discussion of the Background

At present, tanners have a technical challenge to produce leather of high quality, meeting Ecolabeling standards (“ECO Standards”) and environmental concerns from skins of low quality and low grade without using formaldehyde or chrome. Thus, retanning, dyeing, and fat-liquoring require selective chemicals with specific pH. However, the choice of improper chemical combinations with respect to syntans produces a differential pH across the skin, improperly filling the collagen fibers and reducing the leather quality. Therefore, synthesizing a suitable retanning agent that can be used to produce high quality leather that meets ECO Standards, is otherwise environmentally friendly, and is cost effective has proved difficult.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a formaldehyde free resin for tanning leather, a method for synthesizing the resin, a leather tanned with the resin, and a composition of waste water from a tanning process using the resin.

Additional aspects will be set forth in the detailed description which follows, and, in part, will be apparent from the disclosure, or may be learned by practice of the inventive concept.

A method of synthesizing a resin according to an exemplary embodiment includes synthesizing a resin including mixing a first solution including a melamine compound with a second solution including glutaraldehyde to form a third solution, heating the third solution to 35° C. to 90° C. in at a pH above 7 for 5 to 70 minutes, and cooling the third solution to room temperature.

A resin according to an exemplary embodiment includes a compound represented by Chemical Formula 1, which is as follows:

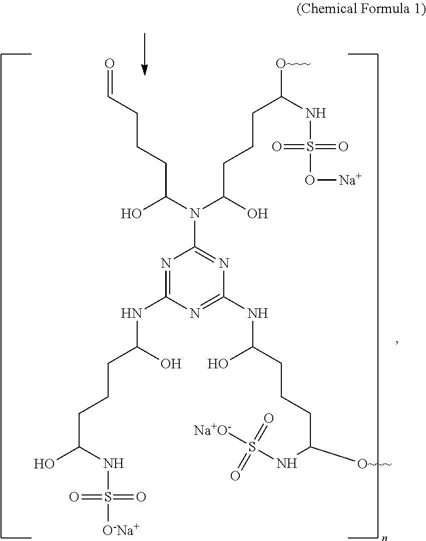

wherein the resin excludes formaldehyde.

A tanned leather according to an exemplary embodiment includes a tear-strength parallel to a backbone of the tanned leather of more than 496 Newton per centimeter (N/cm), a tear-strength perpendicular to the backbone of the tanned leather of more than 630 N/cm, a distension at grain cracking of the tanned leather of more than 7.35 millimeter (mm), a distention at burst of the tanned leather of more than 10.75 mm, a tensile strength parallel to the backbone of the tanned leather of more than 1420 Newton per square centimeter (N/cm²), a tensile strength perpendicular to the backbone of more than 1514 N/cm², a percent elongation perpendicular of more than 41, and a free-formaldehyde content of 0.

A composition according to an exemplary embodiment includes an aqueous solution including a chemical oxygen demand (COD) of less than 15320 parts per million (ppm), a total solids content of less than 20678 ppm, a COD based emission load of less than 21.21 kilogram per ton (kg/ton) of a shaved hide, a total solids based emission load of less than 28.63 kg/ton. The aqueous solution is waste water from tanning leather.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a diagram illustrating the synthesis of sulfonated melamine glutaraldehyde resin according to an exemplary embodiment.

FIG. 2 is a graph illustrating organoleptic properties of leathers retanned with melamine glutaraldehyde resin compared to the organoleptic properties of leathers retanned with commercial melamine formaldehyde resin.

FIG. 3A is an electron microscopic image of the grain surface of leather according to an exemplary embodiment.

FIG. 3B is an electron microscopic image of the grain surface of control leather.

FIG. 3C is an electron microscopic image of the cross-section of leather according to an exemplary embodiment.

FIG. 3D is an electron microscopic image of the cross-section of control leather.

FIG. 4 is a Fourier transform infrared spectroscopy (FTIR) of melamine glutaraldehyde condensate according to an exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements.

For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various elements, compounds, solutions, and/or agents, these elements, compounds, solutions, and/or agents should not be limited by these terms. These terms are used to distinguish one element, compounds, solutions, and/or agents from another element, compounds, solutions, and/or agents. Thus, a first element, compounds, solutions, and/or agents discussed below could be termed a second compounds, solutions, and/or agents without departing from the teachings of the present disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated elements, compounds, solutions, agents, features, steps, operations, components, and/or groups thereof, but do not preclude the presence or addition of one or more other elements, compounds, solutions, agents, features, steps, operations, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As discussed above, synthesizing a suitable retanning agent that can be used to meet ECO Standards has proved difficult. Although, protein hydrolysates and different combinations of tanning agents, such as vegetable based tannins, may be used as fillers in retanning to potentially meet ECO Standards, synthesizing a particular tanning agent that is cost effective and produces high-quality leather, whether its vegan leather (i.e., synthetic leather) or animal-based leather, would be desirable.

Exemplary embodiments use glutaraldehyde to synthesize a tanning agent that meets ECO Standards, is environmentally friendly, is used to produce high quality leather, and is cost effective. Glutaraldehyde is an industrially available aldehyde used as protein crosslinking agent and disinfecting agent. The inventors used glutaraldehyde to obtain a melamine-glutaraldehyde resin that meets ECO Standards, is environmentally friendly, is used to produce high quality leather, and is cost effective. Glutaraldehyde is more eco-friendly and environmentally safer than formaldehyde. For example, the lethal dose at 50% values (LD50) for a rat given glutaraldehyde orally is 1470 mg/kg, but the lethal dose at 50% values (LD50) for a rat given formaldehyde orally is 100 mg/kg. See M. L. Maminski, et al., Simple Urea-Glutaraldehyde Mix Used as a Formaldehyde-Free Adhesive: Effect of Blending with Nano-Al₂O₃, 69 EUR. J. OF WOOD AND WOOD PROD., 505, 505 (2010), available at https://hal.archives-ouvertes.fr/hal-00620890, which is incorporated herein by reference for all purposes including comparing the oral lethal doses of glutaraldehyde and formaldehyde. In other words, glutaraldehyde is over fourteen times safer than formaldehyde on rats according to this data.

Glutaraldehyde has unique properties that make it an effective protein crosslinking agent. Leather produced by oxazolidine has a shrinkage temperature similar to that of glutaraldehyde but is less hydrophilic and less full, because of the molecular weight of oxazolidine is lower than glutaraldehyde in polymerized form. Glutaraldehyde tanned leather is hydrophilic and “plumpy” as compared to tanned leather with formaldehyde. However, the leather color is yellow cast, which turns orange. The orange color causes problems in obtaining desired shades of leathers.

Although there are various available aldehydes with mono and multi-functionalities that may be utilized for tanning and may not have the same color issues as glutaraldehyde tanned leather, the inventors found that condensing glutaraldehyde with melamine and sulfonated with sodium sulfamate to produce a stabilized water soluble resin may impart leather with very little color and has no disturbance in dying. Furthermore, inventors have found that this process also assists in leveling the dye.

A novel melamine based resin using glutaraldehyde and free from formaldehyde resin includes a compound represented by Chemical Formula 1, which is as follows.

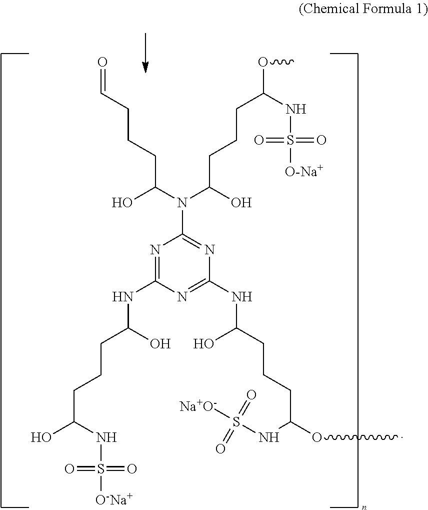

In the compound of Chemical Formula 1 is a sulfonated melamine glutaraldehyde resin and standard chemical elements are noted with the use of n, that represents, that the compound of Chemical Formula 1 may be repeated n number of times depending on the number of moles of melamine, glutaraldehyde, and sodium sulfamate used for synthesizing Chemical Formula 1.

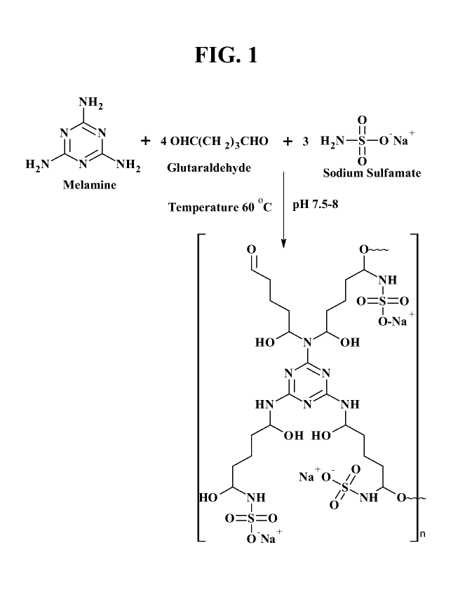

FIG. 1 illustrates a schematic route for synthesizing the sulfonated melamine glutaraldehyde resin according to an exemplary embodiment. As illustrated in FIG. 1, melamine, glutaraldehyde, and sodium sulfamate may react at a temperature of approximately 60° C. in a solvent at a pH of about 7.5 to about 8 according to an exemplary embodiment.

In an exemplary embodiment, melamine, glutaraldehyde, and sodium sulfamate may react at a temperature of approximately 35° C. to 90° C. in a solvent at a pH above 7 for 5 to 70 minutes. For example, melamine, glutaraldehyde, and sodium sulfamate may react at a temperature of approximately 40° C. to 90° C. As another example, melamine, glutaraldehyde, and sodium sulfamate may react at a temperature of approximately 45° C. to 87° C. As another example, melamine, glutaraldehyde, and sodium sulfamate may react at least one of 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., and 90° C.

In addition, the time for reacting melamine, glutaraldehyde, and sodium sulfamate may vary. For example, melamine, glutaraldehyde, and sodium sulfamate may react for 5 to 10 minutes, 5 to 50 minutes, or 10 to 40 minutes. As another example, melamine, glutaraldehyde, and sodium sulfamate may react for 5 to 10 minutes at 75° C. to 90° C. and then cooled to 50° C. to 74° C. for 15 to 45 minutes where the reaction may or may not continue. The reaction of melamine, glutaraldehyde, and sodium sulfamate may occur at any suitable temperature and for any suitable amount of time such as for at least one of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, and 70 minutes.

Moreover, melamine, glutaraldehyde, and sodium sulfamate may react in solvent (e.g., water) at a pH of about 7.1 to about 8.2. For example, melamine, glutaraldehyde, and sodium sulfamate may react in solvent at a pH of about 7.2 to about 8.2 or at a pH of about 7.5 to about 8. As another example, melamine, glutaraldehyde, and sodium sulfamate may react in solvent at any suitable pH such as a pH of at least one of 7.1, 7.2, 7.3, 7.4, 7.5, 7.6, 7.7, 7.8, 7.9, and 8.0.

Synthesizing the sulfonated melamine glutaraldehyde resin may include mixing a basic solution with a sulfamic acid solution to form a first solution comprising a sulfamate ion, adding a second solution containing a melamine compound to the first solution to form a third solution, heating the third solution to about 45 Celsius, adding the a fourth solution containing glutaraldehyde to the third solution, heating the third solution to about 85 Celsius for about 10 minutes at a pH above 7 for 5 to 70 minutes, and cooling the fourth solution to room temperature. The fourth solution may include a 50% glutaraldehyde solution. The basic solution may include at least one of sodium hydroxide, potassium hydroxide, and calcium hydroxide. The basic solution may include about 50% of the basic compound. The sulfamic acid solution may be prepared by mixing water and sulfamic acid in a 1:5 ratio. The ratio of melamine to sulfamate is 1:3. The a ratio of sulfamate to glutaraldehyde is 1:1.3

Preparation of Sulfonated Melamine Glutaraldehyde-Based Resin.

Melamine reacts with glutaraldehyde very rapidly and may form a crosslinked polymer that has no water solubility. In an exemplary embodiment, the polymer was synthesized by condensation of an amino group of melamine with an aldehyde group of glutaraldehyde in a basic medium. Although various reaction parameters were investigated for optimization of the required polymer reaction, it was discovered that the primary product of the reaction is methylolated melamine, which converted to a polymer by further condensation. By further condensation, the resin was converted into a crosslinked insoluble resin. The polymer may be modified chemically by reaction with sodium sulfamate, which acts as a sulfonating agent to form a soluble product, such as a sulfonated melamine formaldehyde condensate. Optimum conditions were discovered to synthesize the stable retanning resin.

In a three necked flask fitted with condenser, stirrer, and thermometer, 105 g water (5.83 moles), 118.92 g sulfamic acid (1.22 moles), 97.60 g 50% strength sodium hydroxide (1.22 moles) were mixed to form sodium sulfamate. An amount of 51.44 g melamine (0.40 mole) was added and heated to 45° C. Afterwards, 326.63 g 50% strength of glutaraldehyde (1.63 moles) was added and the temperature was raised to 85±2° C. to obtain a clear resin solution. The reaction temperature was maintained for ten minutes and then cooled to 60° C. for further condensation of the resin at 60° C. for 30 minutes. The reaction mixture was allowed to cool to room temperature (i.e., 20° C. to 26° C.) after 30 minutes. The solid content of the resin was about 45±1%. The resin, free from formaldehyde (i.e., excluding formaldehyde), was spray dried to obtain a powder form that was used in all leather retanning experiments.

Characterization of the Resin: Estimation of the Solid Content of the Resin.

Solid content of liquid resin was determined by weighing known quantity of the resin in an empty petri dish and drying at 103-105° C. for one hour as per standard procedure²². Solid contents of the product were calculated on a dried weight basis and was found to be 45±1% of the product.

Characterization of the Resin: Viscosity Determination of the Resin.

Viscosity of liquid resin was determined by Brookfield viscometer LV DVE 230 at 25° C. and was found to be 58 cp.

Characterization of the Resin: Evaluation of the Product as Retanning Agent.

Retanning properties of the experimental resin of the sulfonated melamine glutaraldehyde condensate as a retanning agent were assessed by comparison against a control leather developed by commercial melamine formaldehyde-based retanning agent. For comparative post tanning application of control and experimental resins, two similar buffalo wet blue swatches were processed separately in two rotating drums as below.

Chemicals were taken on the basis of shaved weight of a hide in post tanning application. Two hides, each of 125 g were washed with cold water for fifteen minutes in separate rotating drums, followed by addition of 187.5 g of water, 1.875 g of sodium formate and 1.25 g of sodium bicarbonate to neutralize the hides up to pH 5-5.2. After ninety minutes of mixing, water was drained out, additional water (250 g) was added in the drum for washing, and drained after fifteen minutes. Water (125 g) was added for retanning, dying, and fat-liquoring processes. Melamine glutaraldehyde based amino resin (12.5 g) and commercial melamine formaldehyde resin (12.5 g) were added in the separate retanning drums, and each were mixed for forty five minutes. Synthetic fat-liquor (5 g) was added in each of the retanning drums and mixed for sixty minutes. Acid dye (4 g) was added and mixed for thirty minutes to each of the retanning drums. To adjust pH up to 3.8, formic acid (1.875) was added slowly over a period of one hour to each of the retanning drums. Water was drained off from each retanning drum after complete exhaustion of bath. The leather swatches from each drum were washed with water and hooked to dry. The leather swatches were conditioned and staked.

Physical Testing and Hand Evaluation of Leathers.

Samples for physical testing were obtained from the control and experimental leathers as per standard IUP method. See IUP 2, Sampling, 84 J. SOC. LEATHER TECH. CHEM. 303(2000), which is incorporated herein by reference for all purposes including for the purpose of describing how to obtain leather samples for physical testing. Samples were conditioned at a temperature of 80±4° F. and a relative humidity of 65±2% for a period of 48 hours. Tensile strength and percentage elongation at the point that retanned leather break were performed by Tensile testing machine (STM 566 F) by standard procedure. See IUP 6, Sampling, 84 J. SOC. LEATHER TECH. CHEM. 317 (2000), which is incorporated herein by reference for all purposes including for the purpose of describing the standard procedure for testing tensile strength and percentage elongation at the point of breakage.

Tear strength was performed by tear testing machine (STM 566ST) by standard procedure. See IUP 6, Measurement of Tear Load, 84 J. SOC. LEATHER TECH. CHEM. 327 (2000), which is incorporated herein by reference for all purposes including for the purpose of describing the standard procedure for tear strength testing. In addition, grain strength was evaluated by lastometer as per standard procedure. See IUP 9, J. SOC. LEATHER TECH. CHEM. (1996), which is incorporated herein by reference for all purposes including for the purpose of describing the standard procedure for tear strength testing.

Assessment for softness, fullness, roundness, grain tightness, and dye leveling properties of control and experimental leathers were made by hand and visual examinations. Rating of leathers for each functional property was experienced by three persons on a scale of O-m 5 points, where higher point indicates better property.

Analysis of Spent Liquor.

Spent liquors of post tanning from the experimental and control trials were analyzed for Total solids (drying at 103-105° C. for 1.5 hour) and chemical oxygen demand (COD) as per standard procedure. See S. C., Lenore et al. Standard Methods for the examination of water and wastewater, p. 5220 (Port City Press 1999, 20^{th} Ed.), which is incorporated herein by reference for all purposes, including for the purpose of describing the standard procedure for analyzing total solids and chemical oxygen demand. Emission loads per metric ton of processed wet blue of buffalo hides were estimated by multiplying the concentration (mg/1) with total volume of effluent (L).

Free Formaldehyde Analysis in Leather.

Free formaldehyde content was determined from the leather swatches by standard procedure. See IUC 19, 86 J. SOC. LEATHER TECH. CHEM. 289 (2003), which is incorporated herein by reference for all purposes including for the purpose of describing the standard procedure for determining the amount of free formaldehyde in leather swatches. The standard procedure is specific for the determination of released and free formaldehyde in leathers. The method is primarily based on colorimetric analysis.

Reflectance Measurements.

The basic principle is measuring the amount of reflected light from opaque specimen surface at wavelengths of visible spectrum as a fraction of reflected light by white standard illuminated identically. This is called reflectance factor. White standard is perfect reflecting diffuser that shows 100% reflectance at every wavelength. Reflectance measurement of Specimens of the control and experimental leathers were determined by Spectraflash SF 550 (Data Color).

Color Measurements.

Parameters for color measurement such as L, a, b for the control and experimental dyed crust leathers were measured using Spectraflash SF 550 (Data Color). ΔL, is lightness difference; Δa and Δb shows difference in a and b values, respectively, whereas a represents red and green axis, and b is representing yellow and blue axis. Δhereas a, and ΔC are calculated by subtracting corresponding values of experimental leather from the control leather.

Scanning Electron Microscopic Analysis.

Samples from control and experimental dye crust leathers were taken from the standard position of sampling. See IUP 2, Sampling, 84 J. SOC. LEATHER TECH. CHEM. 303 (2000), which is incorporated herein by reference for all purposes including for the purpose of describing how to obtain leather samples for physical testing. Specimens of leather were cut with uniform thickness and washed with acetone. They were coated with 300° A thickness of gold using Ion sputtering device, Model JFC 1500, JEOL Japan. A JEOL JSM 6490 analytical scanning electron Microscope embedded with Energy dispersive X-ray analyzer was used for analysis. Micrographs of grain and cross section of fibers were obtained by operating SEM at high vacuum and voltage of 15 KV with higher magnification levels.

Light Fastness.

Resistance of color of experimental and control dyes crust leathers to an artificial light, Xenon arc lamp, was determined by using standard test procedure. See IUF 402, 86 J. SOC. LEATHER TECH. CHEM. 289 (2003), which is incorporated herein by reference for all purposes including for the purpose of describing the standard test procedure for resistance of color of leather dies to light. Specimens of dyed crust leathers of experimental and control leathers were exposed to light under xenon arc lamp along with blue wool cloths as a standard. Assessment of fastness was carried out by comparing fading of dyed crust leather with that of standard and rating of 1-4 is given. Where 1 represents very low light fastness and 4 represents very high light fastness.

Results of the Experiments.

Melamine based amino resin was synthesized using glutaraldehyde as a condensing agent in replacement of formaldehyde. The required solubility was achieved through sulfonation by sodium sulfamate. The synthesized resin was water miscible like commercial melamine formaldehyde resin. The pH of solution at 10% concentration was 7.85. As there were no such functionalities in the synthesized resin that could be oxidized under light so the color of dyed leather remained unchanged due to excellent light fastness. The particular advantage of glutaraldehyde modified resin was the absence of formaldehyde which is considered health hazard because it is a carcinogen.

Organoleptic Properties.

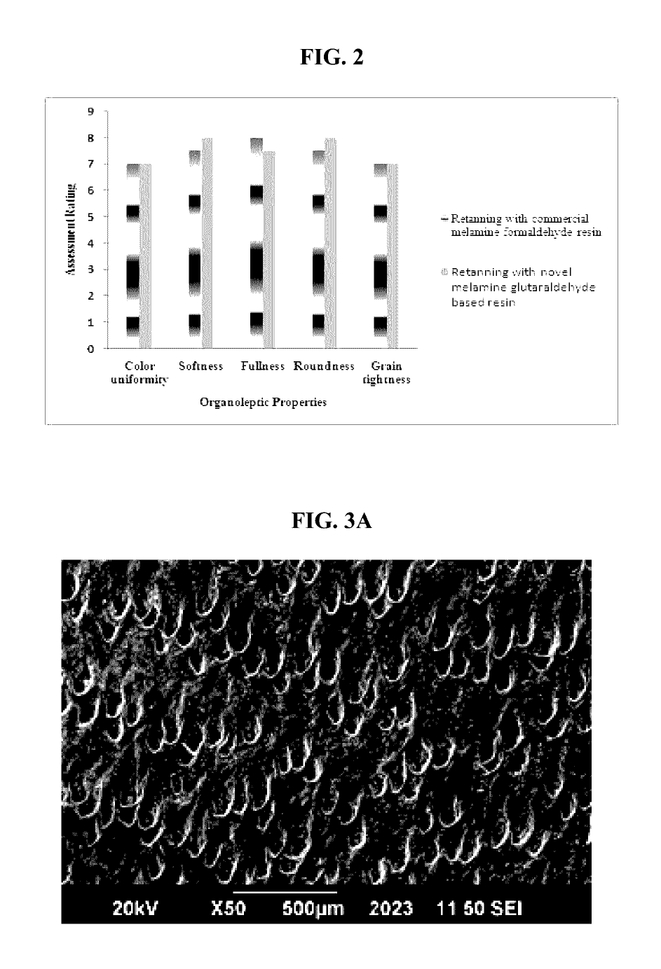

Organoleptic properties, such as fullness and softness of leather fibers, roundness and tightness of leather grain, and color uniformity, after dying for control and experimental crust leathers, were comparatively visually evaluated. An average rating to each functional property of the experiment is shown in FIG. 2. A better property was expressed by a higher number. Softness and roundness of the experimental retanned leather, according to an exemplary embodiment, was higher than the control melamine formaldehyde retanned leather. However, color uniformity, grain tightness of retanned leathers after dying were comparable in control and experimental leathers. It is of note that the fullness of the control melamine formaldehyde retanned leather was higher than the experimental retanned leather.

Physical Characteristics of Leathers.

Tear and tensile strength of dyed crust leathers were performed both along and perpendicular to a backbone line. Resulting values for each side, corresponding to along and perpendicular to backbone, are given in Table 1, below. Grain crack strengths for all dyed crust leathers were carried out. Mean values corresponding to every experiment were averaged and the results are given in Table 1. The results show that all the experimental leathers have comparable tensile strengths, % elongation at break, tear strength, and grain cracking with that of control leathers. However, the increase in tensile strength and tear strength of the experimental resin is due to strong compositing effect of the non-formaldehyde melamine resin with the collagen fibers of the leather. A higher value of % elongation of non-formaldehyde retanned leather is due to the increased flexibility of the character of melamine glutaraldehyde condensate compared to the melamine formaldehyde resin.

Free Formaldehyde Analysis in Leather.

Experimental and control retanned leathers have been evaluated for free formaldehyde by using standard procedure and results have been given in Table 1. There was no detectable free formaldehyde in experimental retanned leather. However, the control retanned leather contained free formaldehyde at the rate of about 145 mg/kg. Experimental retanned leather showed no detectable free formaldehyde because it was synthesized without using formaldehyde.

TABLE 1
Physical and chemical characteristics for leathers retanned with
nonformaldehyde and commercial melamine formaldehyde based
retanning agents.

| | Leather made by using | |
|---|---|---|
| | the following product. | |
| | Nonformaldehyde | Commercial melamine |
| Physicochemical properties | melamine resin | formaldehyde resin |
| Tear strength (N/cm) | 500 | 496 |
| Parallel to backbone | | |
| Tear Strength (N/cm) | 675 | 630 |
| Perpendicular to backbone | | |
| Distension at grain cracking | 7.75 | 7.35 |
| (mm) | | |
| Distension at Burst (mm) | 11.25 | 10.75 |
| Tensile strength (N/cm2) | 1920 | 1420 |
| Parallel to backbone | | |
| % Elongation | 50 | 50 |
| Parallel to backbone | | |
| Tensile strength (N/cm2) | 1720 | 1514 |
| Perpendicular to backbone | | |
| % Elongation | 45 | 41 |
| Perpendicular to backbone | | |
| Free formaldehyde content | None determined | 145 |
| | (N.D.) | |
| Light Fastness | 2.5 | 2.5 |

Spent Liquor Analysis.

Liquid effluent generation has been one of the major problems of the leather tanning industry. These effluents contain large amounts of organic matter, chlorides, and sulfates. The resulting waste water of tannery has high salinity which cannot be easily corrected. With evolving of industry in last few decades, there has also been a growing awareness of need to keep the environment safe. This has been promoted by enforcement of legislations, which have been progressively restrictive to control tannery waste and disposal of tannery waste.

The spent liquors from experimental and control processes were collected. Total solids (TS) and chemical oxygen demand (COD) are two parameters, which were chosen to analyze the environmental impact. Observed value of total solids and chemical oxygen demand may not give direct correlation with environmental consequences, so their values have been converted into emission loads. Values for total solids, chemical oxygen demand, and calculated emission loads are given in Table 2. It has been observed that reduction in TS and COD load has been obtained in formaldehyde free melamine based retanned leather.

TABLE 2
Characteristics of waste water for commercial melamine and
nonformaldehyde melamine retanned leather.

| | Nonformaldehyde | |
|---|---|---|
| | melamine | Commercial melamine |
| Parameters | retanning | formaldehyde retanning |
| Chemical Oxygen Demand | 13610 | 15320 |
| (ppm) | | |
| Total solids (ppm) | 18555 | 20678 |
| Volume of Effluent | 1385 | 1385 |
| (L/ton of shaved hide) | | |
| COD based Emission load | 18.84 | 21.21 |
| (kg/ton of shaved hide) | | |
| Total solids based Emission | 25.69 | 28.63 |
| load (kg/ton of shaved hide) | | |

Scanning Electron Microscopic Analysis.

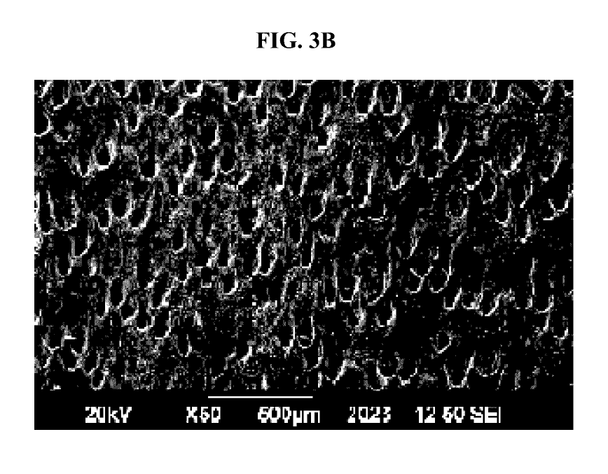

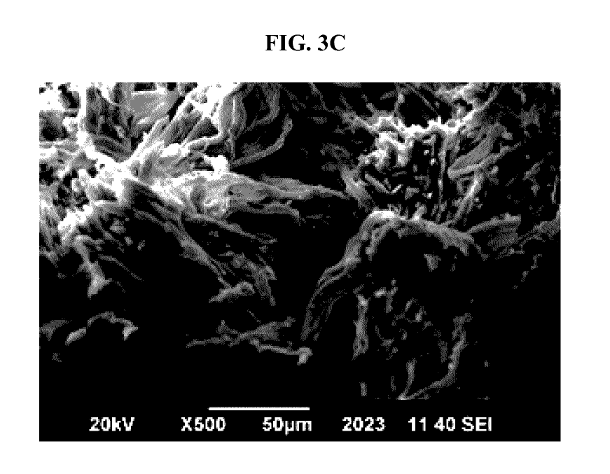

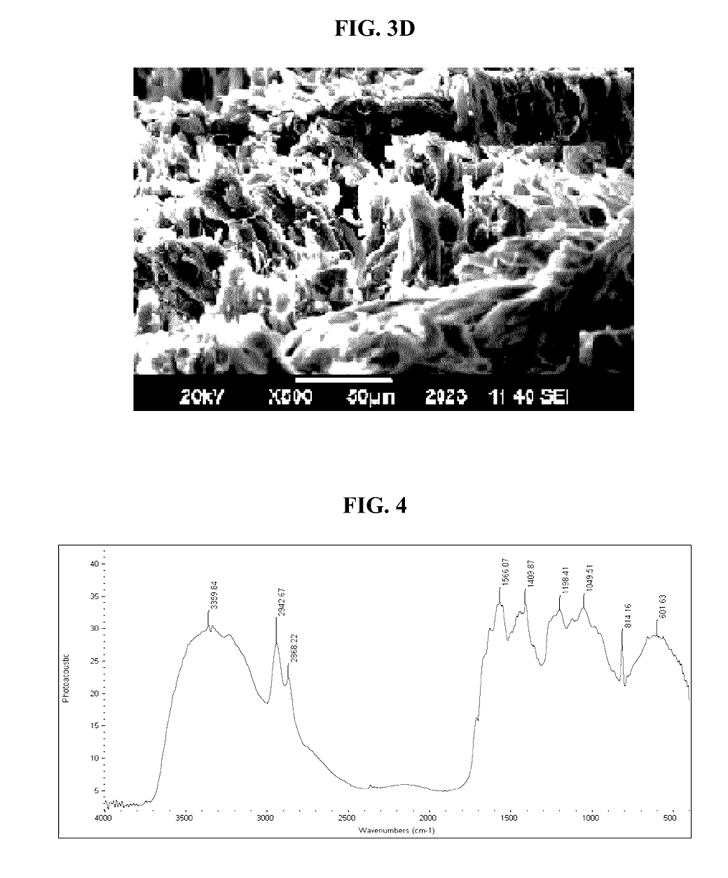

Fullness of retanned leathers can be evaluated by viewing the grain surface and cross section of retanned leather fibers using scanning electron microscopy. FIG. 3A is an electron microscopic image of the grain surface of leather according to an exemplary embodiment. FIG. 3B is an electron microscopic image of the grain surface of control leather.

FIG. 3C is an electron microscopic image of the cross-section of leather according to an exemplary embodiment. FIG. 3D is an electron microscopic image of the cross-section of control leather.

The fiber structure of the experimental retanned leather shown in FIG. 3C has a comparable compactness as the fiber structure of the controlled retanned leather shown in FIG. 3D. In other words, both the formaldehyde and formaldehyde free retanned leather have uniform filling with respect to their retanning agents. However, as shown in FIG. 3C, the fiber structure of the formaldehyde free melamine based retanned leather has more compactness than the formaldehyde retanned leather shown in FIG. 3D. For example, the fibers appear to be thicker and/or closer together in the formaldehyde free retanned leather than the fibers in the retanned leather with formaldehyde.

Color Difference.

Color measurement values for experimental and control retanned leathers are given in Table 3. Experimental leathers show negative value of AL, which correspond to a darker shade. Experimental retanned leather has an overall color difference value of 3.33 in comparison to control leather expressing increase of shade strength between experiment and control leather. Both retanned leathers have uniform shade of dye, which clearly shows equal dispersing and leveling property of resins.

TABLE 3
Color difference measurements of leathers.
Commercial melamine formaldehyde based retanned leather

| Illuminant | L | a | b |
|---|---|---|---|
| D65 | 73.59 | −0.2 | 29.93 |

Non formaldehyde melamine based retanned leather

| Illuminant | L | a | b | ΔL | Δa | Δb |
|---|---|---|---|---|---|---|
| D65 | 70.26 | 1.37 | 36.08 | −3.33 | 1.57 | 6.15 |

| | | | |
|---|---|---|---|
| Distinction of experimental leather | Darker | Red | Yellow |

Structural Elucidation.

FIG. 4 is a Fourier transform infrared spectroscopy (FTIR) of melamine glutaraldehydeondensate according to an exemplary embodiment. The structure of powder resin was characterized by Infrared spectrum as shown in FIG. 4 using DRS accessories 8000 by diluting with KBr in range of 4000-500 cm⁻¹. A broad band at 3359.84 cm⁻¹ is attributed to NH and OH bonds of amine and alcohols. Two signal at 2942.67 cm⁻¹ and 2868.22 cm⁻¹ show antisymmetric and symmetric vibrations of the methylene group. The peak at 1566.07 cm⁻¹ indicates carbonyl functionality of the resin. The peak at 1409.87 cm⁻¹ corresponds to thescissoring vibrations of a methylene group. The peak at 1198.41 cm⁻¹ indicates stretching vibration of the C—S and S═O functionalities of an R—SO₃— group in the resin. The sharp peak at 814.16 cm⁻¹ correspond to deformative vibrations for a 1, 3, 5 triazine ring.

Environmental regulations regarding formaldehyde are generally not met by formaldehyde based resins even when formaldehyde is used in minimum concentrations. Currently environmental legislations require eliminating such products from leather making process. In exemplary embodiments, the inventors have found that it is possible to completely replace formaldehyde in the synthesis of melamine resin as a retanning agent. The condensation of melamine may be made with glutaraldehyde which is stabilized by sulfonation through sodium sulfamate under optimum conditions. There is no detectable free formaldehyde in this novel retanning agent, in contrast to control leather using formaldehyde. Melamine formaldehyde type retanning agents may be completely replaced by this product as observed from physicochemical properties of retanned leathers. Tensile and tear strengths of retanned leather according to exemplary embodiments are better than control leather using formaldehyde. As shown by color difference measurement as well as shown visually, leather that is retanned using the retanning agent, according to an exemplary embodiment, is darker in color in comparison to leather that is retanned the control retanning agent containing formaldehyde. Glutaraldehyde alone affects dying of leather and produces uneven shade on the leather, but after condensing with melamine, dispersing and leveling property of glutaraldehyde based melamine resin has been improved to be comparable to melamine formaldehyde resin, but without the dangerous environmental impact. In summary, retanned leather processed with nonformaldehyde melamine based retanning agent, according to an exemplary embodiment possesses better performance and properties than retanned leather processed with a formaldehyde melamine based retaining agent.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A method of synthesizing a resin, comprising:
mixing a first solution comprising a melamine compound with a second solution comprising glutaraldehyde to form a third solution;
heating the third solution to 35° C. to 90° C. in at a pH above 7 for 5 to 70 minutes; and
cooling the third solution to room temperature.

2. The method of claim 1, further comprising:
mixing a basic solution with a sulfamic acid solution to form a fourth solution comprising a sulfamate ion;
adding a melamine compound to the fourth solution to form the first solution;
heating the first solution to about 45 Celsius;
adding the second solution to the first solution to form the third solution;
heating the third solution to 85 Celsius for about 10 minutes;
cooling the third solution to 60 Celsius; and
maintaining the third solution at 60 Celsius for 30 minutes.

3. The method of claim 2, wherein the second solution comprises 50% glutaraldehyde solution.

4. The method of claim 3, wherein the basic solution comprises at least one of sodium hydroxide, potassium hydroxide, and calcium hydroxide.

5. The method of claim 4, wherein a strength of the basic solution is 50%.

6. The method of claim 4, wherein the sulfamic acid solution is prepared by mixing water and sulfamic acid in a 1:5 ratio.

7. The method of claim 4, wherein a ratio of melamine to sulfamate is 1:3.

8. The method of claim 4, wherein a ratio of sulfamate to glutaraldehyde is 1:1.3.

9. The method of claim 1, wherein the resin is formaldehyde free.

10. A resin, comprising:
a compound represented by Chemical Formula 1, which is as follows: 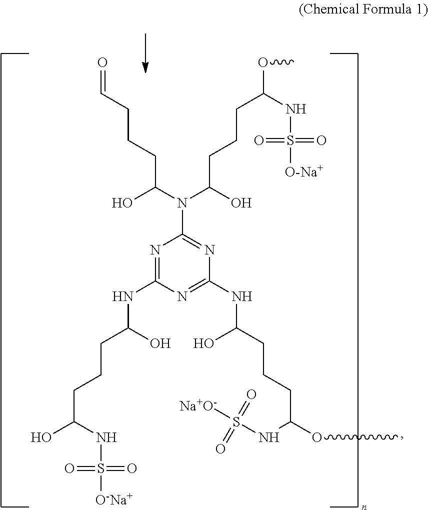
wherein the resin excludes formaldehyde.

11. A tanned leather, comprising,
a tear-strength parallel to a backbone of the tanned leather of more than 496 Newton per centimeter (N/cm);
a tear-strength perpendicular to the backbone of the tanned leather of more than 630 N/cm;
a distension at grain cracking of the tanned leather of more than 7.35 millimeter (mm);
a distention at burst of the tanned leather of more than 10.75 mm;
a tensile strength parallel to the backbone of the tanned leather of more than 1420 Newton per square centimeter (N/cm²);
a tensile strength perpendicular to the backbone of more than 1514 N/cm²;
a percent elongation perpendicular of more than 41; and
a free-formaldehyde content of 0.

12. The tanned leather of claim 11, further comprising:
a percent elongation parallel of 50; and
a light fastness of 2.5.

13. The tanned leather of claim 12, wherein:
the tear-strength parallel to a backbone of the tanned leather is 500 N/cm,
the tear-strength perpendicular to the backbone of the tanned leather is 675 N/cm,
the distension at grain cracking of the tanned leather is 7.75 mm,
the distention at burst of the tanned leather is 11.25 mm,
a tensile strength parallel to the backbone of the tanned leather of 1920 N/cm²,
a tensile strength perpendicular to the backbone of 1720 N/cm², and
a percent elongation perpendicular of 45.

14. A composition, comprising:
an aqueous solution comprising:
a chemical oxygen demand (COD) of less than 15320 parts per million (ppm);
a total solids content of less than 20678 ppm;
a COD based emission load of less than 21.21 kilogram per ton (kg/ton) of a shaved hide;
a total solids based emission load of less than 28.63 kg/ton,
wherein the aqueous solution is waste water from tanning leather.

15. The composition of claim 14, wherein:
the COD of the aqueous solution is 13610 ppm,
the total solids content of the aqueous solution is 18555 ppm,
a COD based emission load of the aqueous solution is 18.84 kg/ton of the shaved hide, and
a total solids based emission load of the aqueous solution is 25.69 kg/ton.
